(19) United States
(12) Patent Application Publication
(10) Pub. No.: US 2008/0141138 A1
(43) Pub. Date: Jun. 12, 2008

(54) APPARATUS AND METHODS FOR PROVIDING A PERSON'S STATUS

(75) Inventors: Chris Kalaboukis, Los Gatos, CA (US); Audrey Y. Tsang, San Francisco, CA (US); Daniel J. Wascovich, San Francisco, CA (US); Matthew Fukuda, San Francisco, CA (US); Edward Stanley Ott, IV, Palo Alto, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/567,335

(22) Filed: Dec. 6, 2006

(51) Int. Cl. G06F 3/00

(52) U.S. Cl. 715/741

(57) ABSTRACT

Disclosed are apparatus and methods for providing and reading status. In general, a user may select from a wide variety of status indicators so as to define his/her current status. The status indicators may correspond to any combination of the user's mood or location, as well as location at a specific time. A status indicator may also promote an item, business, or concept for the user. A status indicator may also be automatically selected based on a particular action of the user. Mechanisms for posting one or more portions of a particular status-providing user's current status indicator to another user's device may also be provided. The status-providing user may also select permission settings for one or more other users to receive specific portions of the status-providing user's status indicator so that a requesting user only receives the portions of the status-providing user's status indicator to which he/she is authorized.

### BACKGROUND OF THE INVENTION

The present invention relates to communicating the status of users in a network and, in particular, to techniques for enabling users to update and manage their status, as well as enabling users to read another user's status.

Messaging systems on the Web or mobile networks often provide some mechanism by which a user can indicate his current status to others on the network. An example of such a mechanism is provided in the messaging interface of the popular Yahoo! Messenger application created by Yahoo! Inc. of Sunnyvale, Calif. On the interface, an icon (e.g., a “smiley face”) and an associated status designation (e.g., “Available”) are associated with the user's screen name. This indicates the user's current online status to the user himself. This “online presence indicator” or OPI may also be represented in the contact lists of other users in the system to whom the user has elected to be visible.

In a messaging application, the user can also access a status menu which provides a number of options for controlling the user's online presence. That is, by selecting one of the available options the user can change the online presence indicator in his own messaging interface and the contact lists of the other users. For example, a yellow smiley face indicates that the corresponding user is online, while a gray “sleepy” face indicates that the user is offline. There are a number of possible online states from which the user may select. The yellow smiley face without any associated symbols indicates the user is currently available.

Although this and other approaches provide a basic status indicator for a user to set and share with other users, it would be beneficial to provide improved techniques by which users can more effectively provide status information and other users can read such status information. Additionally, it would be desirable to expand on the types of status information that may be provided by a user to another user.

### SUMMARY OF THE INVENTION

Accordingly, several embodiments of apparatus and methods for providing and reading status are provided. In general, a user may select from a wide variety of status indicators so as to define his/her current status. The status indicators may correspond to any combination of the user's mood or location, as well as location at a specific time. A status indicator may also promote an item, business, or concept for the user. A status indicator may also be automatically selected based on a particular action of the user. Mechanisms for posting one or more portions of a particular status-providing user's current status indicator to another user's device may also be provided. The status-providing user may also select permission settings for one or more other users to receive specific portions of the status-providing user's status indicator so that a requesting user only receives the portions of the status-providing user's status indicator to which he/she is authorized.

In one embodiment, a method of managing status information for a user is disclosed. The method includes the following operations: a) associating one or more selected status indicators with a particular user's current status indicator based on a user action performed by the particular user; b) associating one or more permission settings with one or more portions of the current status indicator; c) receiving, from another user, a request for particular user's current status indicator; and d) after receiving the request, sending, to the other user, each of the portions (if any) of the particular user's current status indicator for which the corresponding permission setting indicates that the other user is authorized to receive.

In a specific implementation, the user action includes the user selecting a status indicator from a plurality of predefined status indicators, and the user-selected status indicator is associated with the particular user's current status indicator. In another implementation, the user action includes the user selecting a media object as a status indicator, wherein the media object that is selected as a status indicator is associated with the particular user's current status indicator. In yet another embodiment, n the user action includes the user performing an action that is associated with a particular status indicator and wherein the particular status indicator, that is associated with the performed action, is associated with the particular user's current status indicator. In a further aspect, the particular user is queried about whether he/she wants to associate his/her current status indicator with the particular status indicator associated with the performed action, and the particular status indicator is only associated if the particular user provides a positive response. In another embodiment, the user action includes the user providing a custom status description, and the custom status description is associated with the particular user's current status indicator.

In one example, the selected status indicators include any combination of a user mood indicator, a user location indicator, a user location for an indicated time period, or a promotional indicator. In another feature, the permission settings authorize different users for different portions of the current status indicator. In a further aspect, the permission settings authorize more portions of the current status indicator for a first other user that has a closer social connection to the particular user, as compared with a second other user having a less close social connection to the particular user.

In a specific implementation, the request is in the form of a request that the current status indicator be automatically sent to the other user when the current status indicator indicates a particular status. When the current status indicator indicates a particular status, an indication of the particular status is automatically sent to the other user. In another embodiment, the request, for the other user, for the particular user's current status indicator is received after the other user communicates with the particular user using a messenger application, reads the particular user's contact information in an address book, accesses the particular user's blog webpage, or places a telephone call to the particular user. In another aspect, a comment is received, from the other user, about the sent portion(s) of the particular user's current status indicator and sending the comment to the particular user. In another embodiment, operations (a) through (d) are repeated for a plurality of selected status indicators that are provided over a time period and retaining each provided status indicator.

In another embodiment, the invention pertains to an apparatus comprising a processor and memory. The processor and memory are configured for performing one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 is a diagrammatic representation of a network segment in which techniques of the present invention may be implemented in accordance with one embodiment of the present invention.

FIG. 2 is a flowchart illustrating a procedure for handling status input in accordance with one embodiment of the present invention.

FIG. 3 is a flowchart illustrating a procedure for handling status requests in accordance with one implementation of the present invention.

FIG. 4 is a flowchart illustrating a procedure for generating a status request, from the prospective of the requesting user's device, in accordance with one embodiment of the present invention.

FIG. 5A illustrates an example network in which an alert may be generated for a particular user status in accordance with one embodiment of the present invention.

FIG. 5B illustrates an example network in which a response may be generated by a reader of a particular user status in accordance with one embodiment of the present invention.

FIG. 6 is a simplified diagram of a network environment in which specific embodiments of the present invention may be implemented.

FIG. 7 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, embodiments of the present invention allow one or more aspects of a user's current status to be set or provided in a status indicator and also allow another user to read a user's status indicator. A user's status indicator may be set from any device and also read from any device. For example, the device on which a status indicator is set or the device from which a status indicator is read may be in the form of a mobile phone, personal computer (PC), personal digital assistant (PDA, phone, etc. The status indicator of a particular user can be set to indicate any suitable state or combination of states of the user, such as a location, temporal, and/or emotional state of the user. A user's status indicator may also be set to promote an item, event, or place (e.g., provide a link to a user's business, etc.). A status indicator can take a textual, graphical, and/or executable form, such as a text description, photograph, icon, emoticon (e.g., smiley face), video or audio clip. Although an infinite number of status types may be possible, the number of selectable status types for a particular user may be limited to minimize overhead to within reasonable levels.

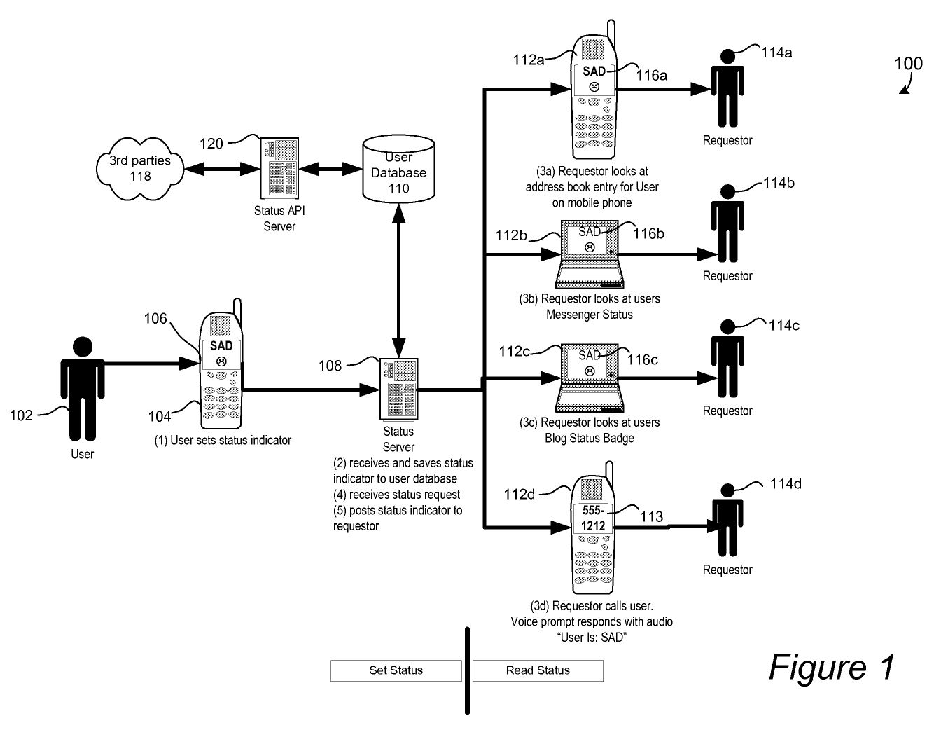

FIG. 1 is a diagrammatic representation of a network segment 100 in which techniques of the present invention may be implemented in accordance with one embodiment of the present invention. In this example, a user 102 sets his/her status indicator on a mobile phone 104 in step (1) although a status indicator may be input on any suitable device. As shown in display 106, the user 102 has selected a status indicator that indicates a sad emotional state by using both the text “sad” and the emoticon “ [symbol] ”.

A status server 108 then receives the status indicator from mobile phone 104 and saves the received status indicator to a user database 110 in step (2). Another user or requester (e.g., 114a-114d) may then send a status request for the user 102 in various manners, for example, in steps (3a) through (3d). Requestor 114a sends a request in step (3a) by looking at an address book entry for the user 102 on her mobile phone 112a so that a status indicator 116a indicating “sad” and the emoticon “ [symbol] ” is displayed on the mobile phone 112a. In another example, Requestor 114b sends a request in step (3b) by looking at a status in a messenger application for the user 102 on her personal computer (PC) device 112b so that a status indicator 116b indicating “sad” and the emoticon “ [symbol] ” is displayed on the PC 112b. Another Requestor 114c initiates a status request, from a PC 112c, for user 102 by looking at the user's (102) blog status badge in step (3c) so that such user's status indicator that indicates “sad” and the emoticon “ [symbol] ” is displayed on PC 112c. User 114d is shown as initiating a status request by calling the user 102 with mobile device 112d (e.g., phone number “555-1212” is displayed in screen 113) in step (3d). In response to the phone call, a voice prompt responds with an audio “User is sad” output from mobile device 112d.

The status server 108 may receive any of these status requests (e.g., initiated in steps 3a-3d) from the corresponding user device (e.g., device 112a-d) in step (4). The status server 108 then retrieves the requested status indicator from user database 110. The status server 108 may be configured to only process a particular request if the requester is authorized to access the requested status indicator or one or more portions of such requested status indicator. The status server 108 may then post the retrieved status indicator (or only authorized portions of such status indicator) to the requester (e.g., 114a-d), via the requestor's device (e.g., 112a-d), in step (5).

In further embodiments, one or more third parties 118 may access a user status indicator from user database 110 via one or more Status API (application programming interface) Servers 120. That is, an API server may be configured to allow a third part to access one or more portions of a user's status indicator from user database 110. In one implementation, the status API server is configured to receive a query for a user's status based on an identity of the user (e.g., account name) and then respond with the user's status indicator (or authorized portions of such status indicator). For instance, a third party may be authorized to access any number of user status indicators and utilize this accessed status information for any type of application. In one application, the status indicators for one or more users may be analyzed over time, compiled, and presented in a graphical format, for example, on group status web page or blog.

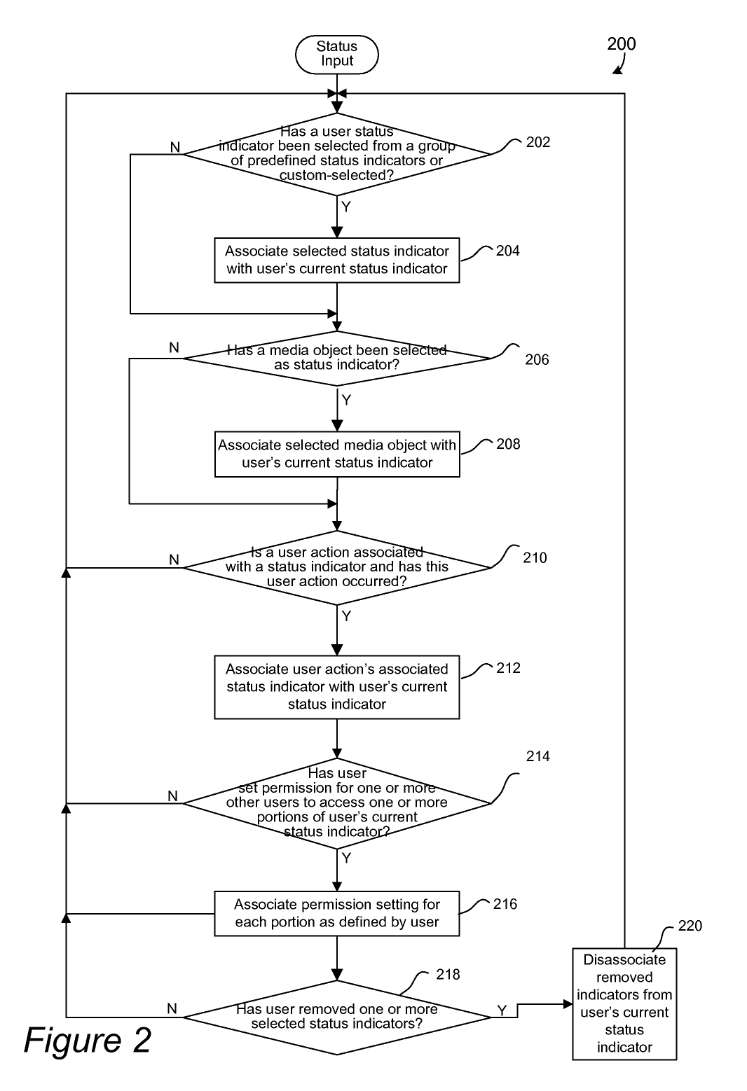

A user's current status indicator may be selected or set in any suitable manner. FIG. 2 is a flowchart illustrating a procedure 200 for handling status input in accordance with one embodiment of the present invention. This flowchart illustrates several possible input mechanisms for allowing a particular user to set and adjust her current status indicator, as well as automated mechanisms for setting a user's current status indicator. Preferably, a particular user's status indicator is only set manually by the particular user. In certain embodiments, however, if the particular user allows it, actions can automatically set the user's current status indicator to a particular value (with or without further user input) as described further below.

The illustrated status selection mechanisms are not meant to limit the scope of the invention. Additionally, the illustrated process flow is shown as including a sequential list of operations for checking various types of status selection mechanisms although the illustrated operations may be executed in any suitable order or in parallel with each other. Also, a user's current status indicator may be set to correspond to a plurality or composite of different status indicators that are each selected in a same or different way. A status selection mechanism may include any combination of the illustrated operations as a separate application or as part of any application, such as a instant messenger application, a blog application, etc.

Referring to FIG. 2, it may be initially determined whether a user status indicator has been selected from a group of predefined status indicators or custom-selected in operation 202. For example, a pull-down menu that lists a plurality of selectable user status options may be provided in a user interface on the user's device. In another example, a user is presented with a list of selectable user status indicators in a single screen with each selectable status indicator having a checkbox adjacent to it. The selectable status indicators may include any of the types of status indicators that are described herein. Alternatively, the user may enter a custom-selected status indicator. For example, the user may type in a text description of his status.

If a user status indicator have been selected, the selected status indicator is then associated with the user's current status indicator in operation 204. For instance, a status data structure is utilized to relate an identity of the user with the selected status indicator and this data structure or the information for such data structure is uploaded to a status server, which then stores such status data structure in a status user database. The status server may also be configured to form such data structure based on the selected status indicator that is received for a particular user.

It may then be determined whether a media object has been selected as a status indicator in operation 206. Any media object may be utilized by a user to indicate her current status. Media objects may include a photograph, video, audio clip, etc. For instance, a user may capture a photo with her camera phone and then upload the captured photo to the status servers to indicate her current status. If a media object has been selected, this selected media object is then associated with the users current status indicator in operation 208, wherein any suitable association process may be utilized as described further herein.

It may then be determined whether a user action is associated with a status indicator and this user action has occurred in operation 210. For instance, certain actions may be defined as indicating a particular emotional or temporal state. In a specific example, if a user is generating a lot of instant messages (e.g., in an instant message or chat application) that utilize words that indicate a happy state, such activities may be defined as meaning the user is happy. If such a user action has occurred, this action's associated status indicator (e.g., happy) may then be automatically associated with the users current status indicator in operation 212, wherein any suitable association process may be utilized as described further herein.

A user may also predefine certain actions as corresponding to particular status indicators and these action indicators may thereafter be automatically set as the user's current status when the user performs such actions. If a user action is associated with a particular status indicator, the user may also be queried to verify whether he wishes to set his current status indicator to the action's associated status indicator. For instance, in the chat example, the user may be asked “You seem to be doing a lot of laughing so can we set your status to ‘happy’?” The query may not be triggered if the user's status indicator already is set to the status state (e.g., happy) that is associated with the user action.

It may then be determined whether a user has set permission for one or more other users to access one or more portions of the current users status indicator in operation 214. If the user has set permission, the permission setting for each portion is then associated as defined by the user in operation 216, wherein any suitable association process may be utilized as described further herein. A user's current status indicator may be a composite of the status types outlined herein and may also include a plurality of descriptions for each status type. A user may set permission for different other users to access different portions of a particular status type and/or to access different status types. For example, a particular user may set permission to be specific to the other user's amount of closeness within the particular user's social circle. In a specific example, a student could have a composite status indicator “at school/bored” composite status for his friends and an “at school/math class” composite status indicator for his parents. A best friend could be permitted to see a status indicator that specifies “at school/math class/bored/coffee after class.” A user may also select permission for all users to share public status indicators (e.g., “at school”). In other words, different users or groups of users may be permitted to see varying descriptive amounts of a particular user's current status indicator. This permission arrangement allows the user to have flexibility in communications to different social groups.

Permission may be selected using any suitable interface mechanism. In one implementation, the user can enter a list of user identities for each portion of a selected status indicator or for the entire selected status indicator. Each time the user adds a new selected status indicator, the user can then select a list of authorized users who can access such new selected status indicator or who can access which portions of such new selected status indicator.

In addition to adding new status indicators to a particular user's current status indicator, a particular status indicator (or any portion of same) can be removed from the user's current status indicator. It may then be determined whether the user has removed one or more selected status indicators in operation 218. If any status indicators have been removed, the removed status indicators are then disassociated from the current status indicator in operation 220. For instance, the removed status indicator is removed from being associated with the user in the user database. The procedure 200 may be repeated any number of times for any number of users, and the current status indicator for each user may be updated at any frequency.

A particular user's or group of user's current status indicator may be logged or recorded at each update so as to archive a historical record of one or more user's status. The archived status information may then be used in any suitable manner. For example, a user status blog may be formed for a particular user to show their status over time. In another example, a group status blog may display the average status of a group of users, in specific status categories such as mood, over time.

Once a particular user's status indicator is set, another user may access the particular user status, for example, by sending a status request for such particular user, if permitted such access. Any suitable mechanism may be utilized for handling status requests. For example, a status server may implement a status request handling mechanism for receiving and handling status requests from various status request applications on various devices that are used by various users.

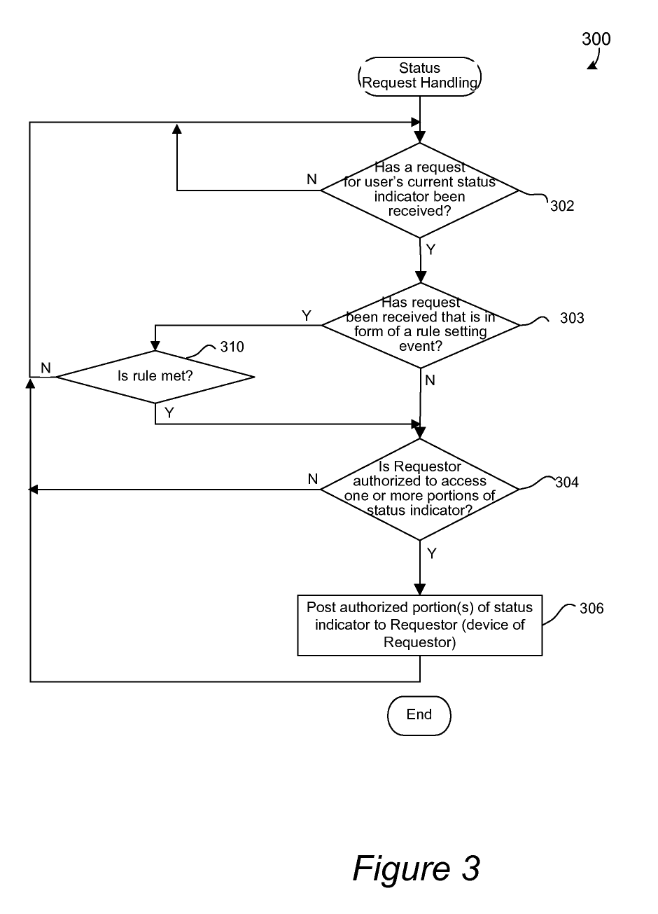

FIG. 3 is a flowchart illustrating a procedure 300 for handling status requests in accordance with one implementation of the present invention. Initially, it may be determined whether a request for user's current status indicator has been received in operation 302. The procedure 300 may continue to wait for such a request.

When a request for a user status has been received, it may then be determined whether this request that has been received is in the form of a rule setting event in operation 304. In one embodiment, a requester may set up a rule for receiving status indicator updates from a particular user or a such a rule may be set up by the owner of the status indicator. A third party API may also leverage a rule to display a status indicator (e.g., an alert) on their application. Thus, the request in this situation is in the form of a rule being set for a particular user. The rule may specify that the status indicator is to be sent to a particular user when the status indicator is set to or indicates a particular value or state.

After a rule is set up, a user or third party API may also subscribe to receive an alert based on such rule. For instance, a particular subscriber may be associated with a particular rule of a particular user and their current status indicator in the user database after the status server receives a request from the particular subscriber to subscribe to a particular rule of the particular user.

A rule feature may be especially useful for sending alerts when a status of a user reaches an emergency state. For example, a teenager may wish to set up an emergency status, which he can initiate from his mobile phone, that would then automatically alert his parents that he needs immediate assistance. An emergency status indicator can also include geopositional information if available, from a geopositional satellite (GPS) device in the status-generating user's mobile phone or other type of mobile device.

If a rule has been set, it may then be determined whether the rule is met in operation 310. After a rule has been set for a particular user, it may be repeatedly determined whether the rule has been met. For example, each change to a user's current status indicator may trigger a check as to whether the change has resulted in a rule being met (e.g., status is set to “emergency”) for such user.

If a rule has been met or the request is not in the form of a rule setting event (e.g., in the form of a request sent by a requester), it may then be determined whether the requester is authorized to access one or more portions of the requested status indicator in operation 304. For instance, a particular requester may be authorized only to access a subset of the status indicator based on their relative closeness to the status owner's social circle. If the requester is authorized to access one or more portions of the status indicator, the authorized portions are then posted to the requester, e.g., to the device of the requester, in operation 306. Although the receiver of a user's current status indicator is referred to herein as a “requester”, the receiver does not necessarily make a status request, for example, in the alert situation. The procedure 300 for handling status output may be repeated for any number of status requests.

The form of the status indicator of a particular status-user as output to the requester may differ from the form that is input by the status-user. For example, a status-user may select a text description that is posted to a requester in the form of an audio clip. In sum, a status indicator may be input in a specific text, video, audio, or pictorial form and output in a different one of these forms. In another example, an emoticon, that is selected by a status-user, may be converted to a corresponding alphanumeric description that is output to the requester. Also, the status indicator may be filtered so as to post only portions of the status indicator for which the requester is authorized.

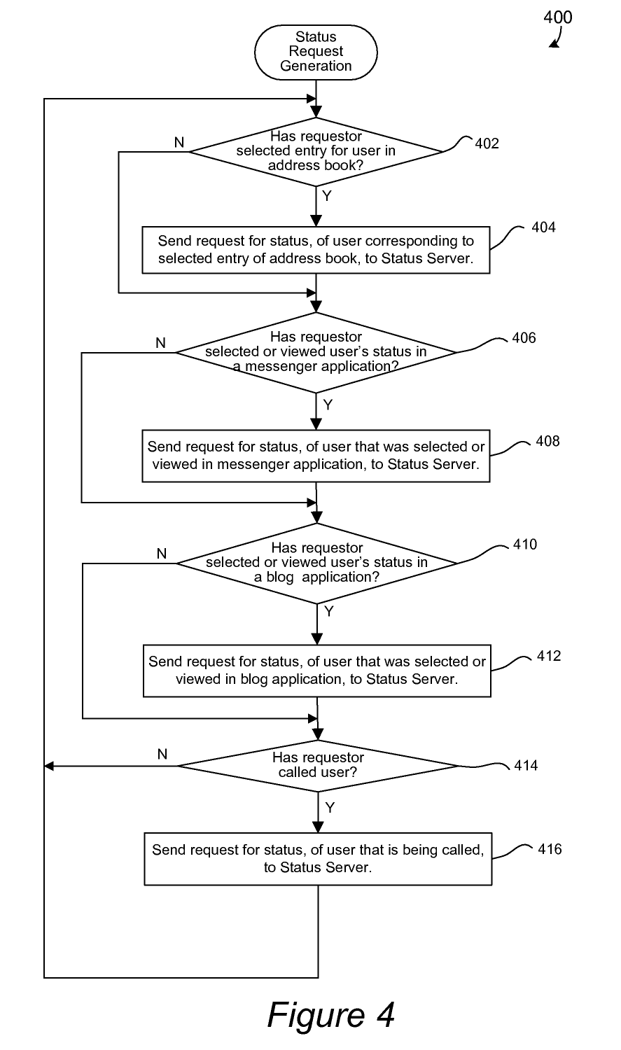

FIG. 4 is a flowchart illustrating a procedure 400 for generating a status request, from the prospective of the requesting user's device, in accordance with one embodiment of the present invention. Any combination of the operations of this process may be implemented on a device utilized by a status requester, and may depend on the particular applications implemented on such device. For instance, certain ones of the request handling operations may be implemented in each type of application in which it may be useful to access a user status.

Referring to FIG. 4, it may be determined whether the requester has selected an entry for a user in an address book application in operation 402. If an address entry has been selected, a request for status of the user corresponding to the selected entry of the address book may then be sent to the status server in operation 404. It may also be determined whether a requester has selected or viewed a user status in a messenger application in operation 406. If a status has been viewed in a messenger application, a request for status of the user that was selected or viewed in a messenger application may then be sent to the status server in operation 408. It may also be determined whether a requester has selected or viewed a user status in a blog application in operation 410. A request for the status of the user that was selected or viewed in the blog application may then be sent to the status server in operation 412. It may also be determined whether a requester has called the user, e.g., from a telephone device, in operation 414. If such a call has been placed, a request for status of the user that is being called may be sent to the status server in operation 416. The procedure 400 may be repeated for any number and type of request on any type of device and software application.

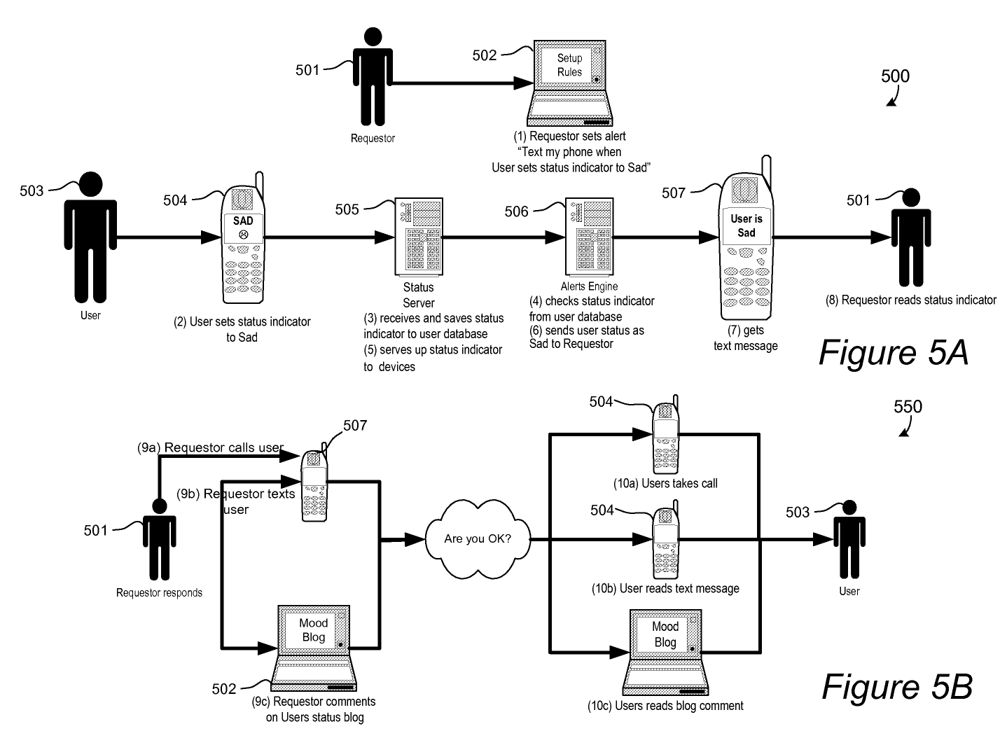

FIG. 5A illustrates an example network 500 in which an alert may be generated for a particular user status in accordance with one embodiment of the present invention. As shown in step (1), a user or requester 501 sets an alert to send another user's 503 status to the requester 501 (e.g., to the requestor's phone) when the status is set to “sad”. In this example, the alert is set up at a different device 502 (i.e., PC 502) then is to receive the alert (i.e., phone 507). This alert setting may be stored in an alert engine 506 that is configured to check whether the rules, that have been set up, are met.

User 503 then sets her status to “sad” on mobile phone 504 in step (2). This status update is then received and saved by status server 505 in a user database (not shown) in step (3). The alert engine 506 may continue to check the user database for status updates to determine whether the status for user 503 has been set to “sad” in step (4). Alternatively, a status change by user 503 may be sent to the alert engine 506 or the alert engine may make a status request for user 503 to the status server 505. In the later example, the status server sends the status indicator for user 503 to the alerts engine 506 in step (5). In either of the implementation examples, the alert engine 506 only sends a user status that indicates “sad” to user 501 in step (6). As a result, the device 507 of requester 501 gets a text message indicating a “sad” status for user 503 in step (7), which the requester 501 reads in step (8).

A status requester may be allowed to respond to a receipt of a particular status indicator. The response may take any suitable form and be in response to any type of status indicator. FIG. 5B illustrates an example network 550 in which a response may be generated by a reader of a particular user status in accordance with one embodiment of the present invention. The status reader in this example is the user 501 of FIG. 5A. After the requester 501 receives a status indicator from user 503 indicating “sad”, requester 501 may then generate a response to such status by either calling user 503 in step (9a), texting user 503 in step (9b), or commenting on the user's status blog in step (9c). The response may ask whether the user 503 with the “sad” status is ok. The “sad” user 503 may receive this response by taking the call from the status requester 501 in step (10a), reading the text message from the requester 501 in step (10b), or reading the blog comment from the requester 501 in step (10c).

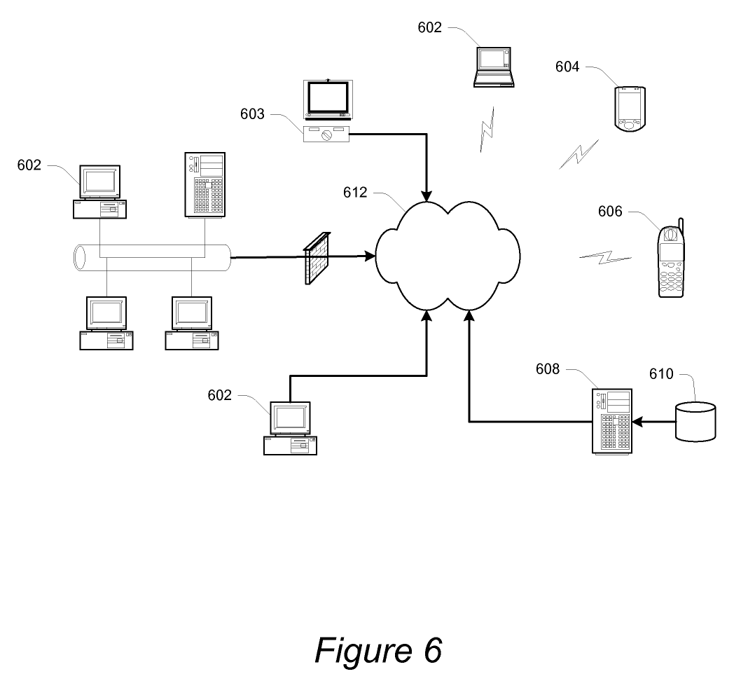

Embodiments of the present invention may be employed to set and read status indicators in any of a wide variety of computing contexts. For example, as illustrated in FIG. 6, implementations are contemplated in which the relevant population of users interact with a diverse network environment via any type of computer (e.g., desktop, laptop, tablet, etc.) 602, media computing platforms 603 (e.g., cable and satellite set top boxes and digital video recorders), handheld computing devices (e.g., PDAs) 604, cell phones 606, or any other type of computing or communication platform.

And according to various embodiments, status indicators that are processed in accordance with the invention may be obtained and/or read using a wide variety of techniques. For example, status indicators representing a user's interaction with a local application, web site or web-based application or service may be accomplished using any of a variety of well known mechanisms for recording a user's behavior. However, it should be understood that such methods of indicating status are merely exemplary and that status information may be collected in many other ways.

Once a status indicator has been selected, this status indicator may be handled according to the invention in some centralized manner. This is represented in FIG. 6 by server 608 and data store 610 that, as will be understood, may correspond to multiple distributed devices and data stores. The invention may also be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

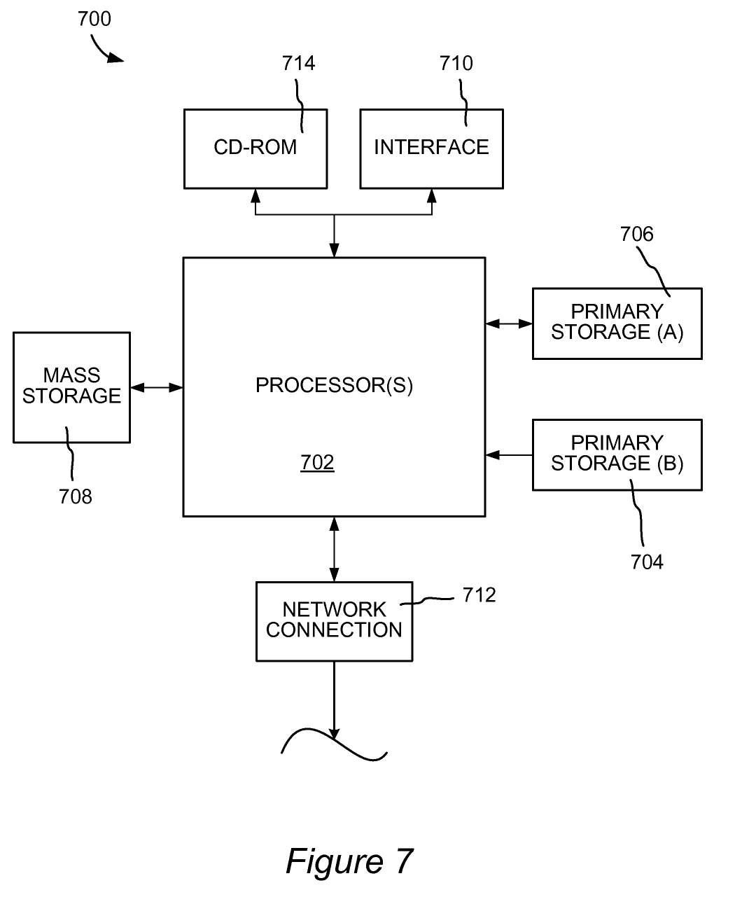

FIG. 7 illustrates a typical computer system that, when appropriately configured or designed, can serve as a status input mechanism and/or status indicator output mechanism and/or status reader of this invention. The computer system 700 includes any number of processors 702 (also referred to as central processing units, or CPUs) that are coupled to storage devices including primary storage 706 (typically a random access memory, or RAM), primary storage 704 (typically a read only memory, or ROM). CPU 702 may be of various types including microcontrollers and microprocessors such as programmable devices (e.g., CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described herein. A mass storage device 708 is also coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 is also coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications network using an external connection as shown generally at 712. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store the status indicator information, permission settings, rule settings, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

1. A method of managing status information for a user, comprising:
a) associating one or more selected status indicators with a particular user's current status indicator based on a user action performed by the particular user;
b) associating one or more permission settings with one or more portions of the current status indicator;
c) receiving, from another user, a request for particular user's current status indicator;
d) after receiving the request, sending, to the other user, each of the portions (if any) of the particular user's current status indicator for which the corresponding permission setting indicates that the other user is authorized to receive.

2. A method as recited in claim 1, wherein the user action includes the user selecting a status indicator from a plurality of predefined status indicators, wherein the user-selected status indicator is associated with the particular user's current status indicator.

3. A method as recited in claim 1, wherein the user action includes the user selecting a media object as a status indicator, wherein the media object that is selected as a status indicator is associated with the particular user's current status indicator.

4. A method as recited in claim 1, wherein the user action includes the user performing an action that is associated with a particular status indicator and wherein the particular status indicator, that is associated with the performed action, is associated with the particular user's current status indicator.

5. (canceled)

6. A method as recited in claim 1, wherein the user action includes the user providing a custom status description, wherein the custom status description is associated with the particular user's current status indicator.

7. A method as recited in claim 1, wherein the selected status indicators include any combination of a user mood indicator, a user location indicator, a user location for an indicated time period, or a promotional indicator.

8. A method as recited in claim 1, wherein the permission settings authorize different users for different portions of the current status indicator.

9-10. (canceled)

11. A method as recited in claim 1, wherein the request, for the other user, for the particular user's current status indicator is received after the other user communicates with the particular user using a messenger application, reads the particular user's contact information in an address book, accesses the particular user's blog webpage, or places a telephone call to the particular user.

12. (canceled)

13. A method as recited in claim 1, further comprising repeating operations (a) through (d) for a plurality of selected status indicators that are provided over a time period and retaining each provided status indicator.

14. (canceled)

15. An apparatus of managing status information for a user, comprising at least a processor and a memory, wherein the processor and/or memory are configured to perform the following operations:
a) associating one or more selected status indicators with a particular user's current status indicator based on a user action performed by the particular user;
b) associating one or more permission settings with one or more portions of the current status indicator;
c) receiving, from another user, a request for particular user's current status indicator;
d) after receiving the request, sending, to the other user, each of the portions (if any) of the particular user's current status indicator for which the corresponding permission setting indicates that the other user is authorized to receive.

16. An apparatus as recited in claim 15, wherein the user action includes the user selecting a status indicator from a plurality of predefined status indicators, wherein the user-selected status indicator is associated with the particular user's current status indicator.

17. An apparatus as recited in claim 15, wherein the user action includes the user selecting a media object as a status indicator, wherein the media object that is selected as a status indicator is associated with the particular user's current status indicator.

18. An apparatus as recited in claim 15, wherein the user action includes the user performing an action that is associated with a particular status indicator and wherein the particular status indicator, that is associated with the performed action, is associated with the particular user's current status indicator.

19. An apparatus as recited in claim 18, further comprising querying the particular user about whether he/she wants to associate his/her current status indicator with the particular status indicator associated with the performed action and only associating the particular status indicator if the particular user provides a positive response.

20. An apparatus as recited in claim 15, wherein the user action includes the user providing a custom status description, wherein the custom status description is associated with the particular user's current status indicator.

21. An apparatus as recited in claim 15, wherein the selected status indicators include any combination of a user mood indicator, a user location indicator, a user location for an indicated time period, or a promotional indicator.

22. An apparatus as recited in claim 15, wherein the permission settings authorize different users for different portions of the current status indicator.

23. (canceled)

24. At least one computer readable storage medium having computer program instructions stored thereon that are arranged to perform the following operations:
a) associating one or more selected status indicators with a particular user's current status indicator based on a user action performed by the particular user;
b) associating one or more permission settings with one or more portions of the current status indicator;
c) receiving, from another user, a request for particular user's current status indicator;
d) after receiving the request, sending, to the other user, each of the portions (if any) of the particular user's current status indicator for which the corresponding permission setting indicates that the other user is authorized to receive.

25. At least one computer readable storage medium as recited in claim 24, wherein the user action includes the user selecting a status indicator from a plurality of predefined status indicators, wherein the user-selected status indicator is associated with the particular user's current status indicator.

26. At least one computer readable storage medium as recited in claim 24, wherein the user action includes the user selecting a media object as a status indicator, wherein the media object that is selected as a status indicator is associated with the particular user's current status indicator.

27. At least one computer readable storage medium as recited in claim 24, wherein the user action includes the user performing an action that is associated with a particular status indicator and wherein the particular status indicator, that is associated with the performed action, is associated with the particular user's current status indicator.

28. At least one computer readable storage medium as recited in claim 24, wherein the user action includes the user providing a custom status description, wherein the custom status description is associated with the particular user's current status indicator.

29. At least one computer readable storage medium as recited in claim 24, wherein the selected status indicators include any combination of a user mood indicator, a user location indicator, a user location for an indicated time period, or a promotional indicator.

30. At least one computer readable storage medium as recited in claim 24, wherein the permission settings authorize different users for different portions of the current status indicator.

31. At least one computer readable storage medium as recited in claim 24, wherein the request is in the form of a request that the current status indicator be automatically sent to the other user when the current status indicator indicates a particular status, and wherein when the current status indicator indicates a particular status, an indication of the particular status is automatically sent to the other user.
